(19) United States
(12) Patent Application Publication
(10) Pub. No.: US 2006/0204107 A1
(43) Pub. Date: Sep. 14, 2006

(54) Object recognition system using dynamic length genetic training

(75) Inventors: Peter J. Dugan, Ithaca, NY (US); Patrick Ouellette, Lanark (CA)

Correspondence Address: WALL MARJAMA & BILINSKI, 101 SOUTH SALINA STREET, SUITE 400, SYRACUSE, NY, 13202, US

(73) Assignee: Lockheed Martin Corporation, Bethesda, MD (US)

(21) Appl. No.: 11/072,591

(22) Filed: Mar. 4, 2005

(51) Int. Cl. G06K 9/62; G06K 9/64

(52) U.S. Cl. 382/217; 382/209; 382/159

(57) ABSTRACT

The present invention is directed to an object recognition system. The system includes a database having stored therein a trained reference vector. The trained reference vector includes a finite string of weighted reference feature elements optimized using a genetic algorithm which uses a dynamic length chromosome. The trained reference vector is optimized relative to a fitness function. The fitness function is an information based function. The trained reference vector corresponds to a known object or class of objects. A sensor is disposed in a surveilled region and configured to generate sensor data. The sensor data corresponds to objects disposed in the surveilled region. A recognition module is coupled to the sensor and the at least one database. The recognition module is configured to generate data object vectors from the sensor data. Each data object vector corresponds to one object. The recognition module is configured to combine the reference vector with each data object vector to obtain at least one fusion value for that vector. The fusion value is compared with a predetermined threshold value to thereby measure the likeness of the at least one object relative to the known object or class of objects.

### FIELD OF THE INVENTION

The present invention relates generally to pattern recognition systems, and particularly to an object recognition system that is configured to recognize objects based on color, size, shape, and other stylistic features using a hybrid system approach that combines rapid training and multi-sensor feature fusion.

### BACKGROUND OF THE INVENTION

There is a need for automated pattern and/or object recognition capability for a number of applications. Computerized systems must be programmed or configured to analyze patterns and make decisions based on that analysis. In most systems, a sensor is employed to capture measurement data relating to a monitored region of interest. The captured data is analyzed to determine if an event occurred, or to recognize a predetermined pattern or object. For example, sensors may be employed to capture speech or other audio signals, seismic data, sonar data, electrical waveforms, and other electromagnetic signals, such as radar signals. Image sensor data may be obtained for text, optical symbols, and images of objects, such as vehicles. Pattern recognition may also be applied to applications relating to personal identification, such as iris recognition, facial feature recognition, among others.

The object or pattern recognition process typically includes three (3) main steps. First, the system must determine which features are important. Second, the system must extract features that are statistically significant from the sensor data. Finally, the system must recognize the event or object after analyzing the extracted feature data. Of particular importance is determining whether the extracted feature data matches a predetermined object or pattern stored in the system.

In one approach, a system has been considered that includes a low-level neural module for region of interest detection, in conjunction with a high-level recognition module for recognizing complex objects, such as faces. In another approach, a back propagation neural network for facial verification was considered. The neural network was trained on pixel vectors formed from compressed facial images. Neural networks may also be used in vehicle recognition systems and other object recognition problems.

One problem associated with object and/or pattern recognition systems that employ neural networks relates to the large number of test images required to train the system. Further, the time required to train or teach the network is typically rather extensive.

What is needed is an object recognition system that combines different types of sensor inputs, be trained quickly, using a relatively small number of test images, and can dynamically prioritize the recognition requirements based on the search criteria.

### SUMMARY OF THE INVENTION

The present invention is directed to an object recognition system that combines different types of sensor inputs, be trained quickly, using a relatively small number of training samples, and can dynamically prioritize the recognition requirements based on the search criteria.

One aspect of the present invention is directed to an object recognition system. The system includes at least one sensor disposed in a surveillance region and configured to generate sensor data. The sensor is linked to a database having stored therein, objects from the sensory hardware along with a plurality of trained template vectors. Each trained template vector is associated with a unique search for a unique individual object or given class of objects. Templates contain region of interest (ROI) information, feature list information, and a list of feature weights that are derived from the training process using Genetic Optimization. Searches are performed using a combination of manual or automated ROI regions. Weights in each template are thereby optimized through application of a specialized fitness routine working in conjunction with a Genetic Algorithm. Each new template is trained using the Genetic Algorithm for specific object or search pattern for the recognition module. The training vector varies in length and requires a Genetic Algorithm that can handle dynamic length chromosomes. The chromosomes represents weights in which each weight is used to multiply by a feature value. Feature values are determined by extracting data from the database objects based on rules set forth in the template. Weighted features are then fused together into a single value whereby a predetermined threshold value is used in order to measure the likeness of the at least one object, relative to the known object or class of objects.

According to another aspect, the present invention includes an object recognition system. The system comprises at least one database that includes at least one trained reference vector and at least one training image corresponding to the at least one trained reference vector. Each of the at least one trained reference vectors includes a plurality of trained model object features optimized using a genetic algorithm. The trained reference vector is optimized relative to a fitness function. The fitness function is an information based function. The trained reference vector corresponds to a known object or class of objects. A user interface is configured to input user specified data into the system. At least one sensor is disposed in a surveilled region and configured to generate sensor data corresponding to at least one object disposed in the surveilled region. At least one computer is coupled to the at least one sensor, the user interface, and the at least one database. The at least one computer is configured to do the following: obtain a trained reference vector from the at least one database; generate at least one data object vector from the sensor data, the data object vector including a plurality of data object features; compare each data object feature to a corresponding trained model object feature to obtain a plurality of scores; and combine the plurality of scores to obtain a fusion value, the fusion value representing a measure of the likeness of the at least one object relative to the known object or class of objects. Each of the likeness measures are compared against a scalable decision level. Objects that have likeness measures that exceed this level are returned as possible matches. In the event that all likeness measures fall below the decision level, then the system will return with either, “no objects found in the database”, or a scalable number objects that “match the closest” for the specific search.

According to another aspect, the present invention includes an object recognition method. The method includes the step of providing a trained reference vector using a genetic algorithm. The trained reference vector includes a plurality of trained model object feature weights optimized using a genetic algorithm. The trained reference vector is associated to a known object or class of objects. The trained reference vector is optimized relative to a fitness function. The fitness function is based on inter cluster and intra (or between) cluster information levels. An electronic representation of at least one object is captured in a surveilled environment. A data object vector is derived from the electronic representation of each of the at least one objects. The data object vector includes a plurality of data object feature elements. The at least one data object vector is compared with the trained reference vector to obtain a comparison metric, or likeness measure. Each of the likeness measures is compared against a scalable decision level. Objects that have likeness measures that exceed this level are returned as possible matches. In the event that all likeness measures fall below the decision level, then the system will return with either, “no objects found in the database”, or a scalable number objects that “match the closest” for the specific search.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a high level block diagram of the system according to the present invention;

FIG. 2 is a component level block diagram showing the major hardware subsystems in accordance with one embodiment of the present invention;

FIG. 3 is a functional block diagram showing the major software modules of the system in accordance with an embodiment of the present invention;

FIG. 4 is a component level block diagram showing the mode selection mechanism in accordance with another embodiment of the present invention;

FIG. 5 is a component level block diagram of the training module in accordance with the present invention;

FIG. 6 is a functional diagram of the training module shown in FIG. 5;

FIG. 7 is a flow diagram showing a method for training a template;

FIG. 8 provides examples of training inputs to the training module;

FIG. 9 is a diagram illustrating genetic weight optimization;

FIG. 10 is a functional block diagram of the recognition module in accordance with another embodiment of the present invention;

FIG. 11 is a flow diagram showing the data fusion process used in FIG. 8;

FIG. 12 is a diagram showing a pattern match example; and

FIG. 13 is a diagram showing an individual match example.

### DETAILED DESCRIPTION

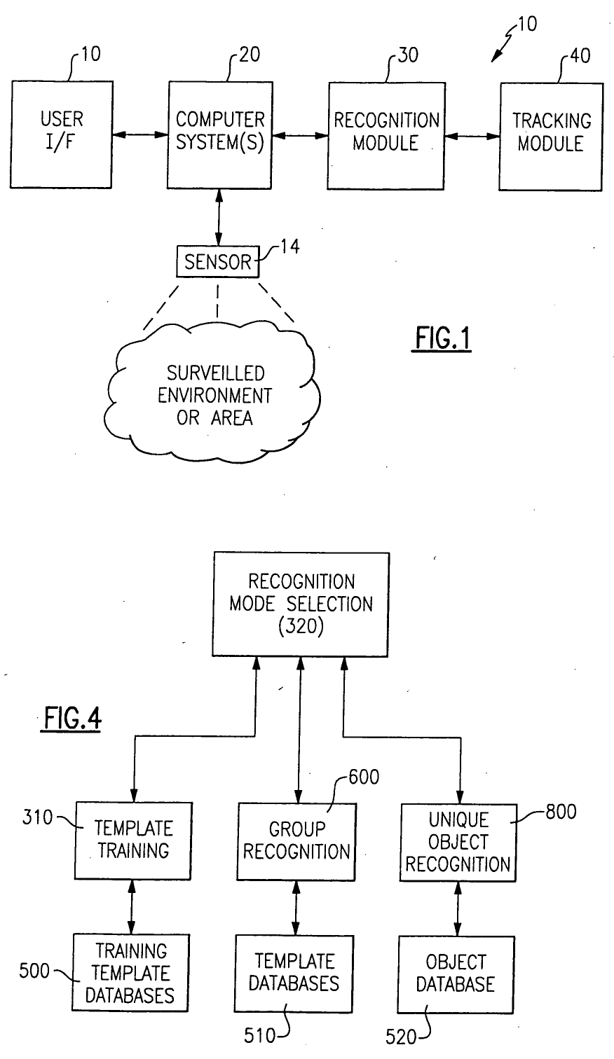

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the object/pattern recognition system of the present invention is shown in FIG. 1, and is designated generally throughout by reference numeral 10.

The present invention is directed to an object recognition system. The system is configured to search for individual objects or classes of objects (or groups). The system may operate in “group” or “individual” mode where each mode executes by way of an on-line (or off-line training procedure). The training mode uses an evolution based process that allows for scalable training time. A large training set is not required, although not limited to smaller sets. Training speeds are directly related to the level and complexity of the feature data. By combining the feature data at a higher level, features are numerically less complex, requiring fewer inputs to the fusion device. Aside from reduced feature complexity, the fitness function measures training accuracy based on two groups of data; these groups represent matching and non-matching objects.

The system further includes a database having stored therein a trained reference vector. The trained reference vector (for either group mode or individual mode) includes region of interest (ROI) information, feature list information, and a finite string of optimized feature weights. The optimized feature weights are derived by on-line training, but may include off-line training as well, using the Evolution Based Optimization process along with user defined parameters (such object color and ROI data) The trained reference vector is optimized relative to a fitness function. The fitness function is an information based function that allows for rapid training based on a mined data set. The trained reference vector corresponds to a known object or class of objects. A sensor is disposed in a surveilled region and configured to generate sensor data. The sensor data corresponds to objects disposed in the surveilled region. A recognition module is coupled to the sensor and the at least one database. The recognition module is configured to generate data object vectors from the sensor data. Each data object vector corresponds to one object. The recognition module is configured to combine the reference vector with each data object vector to obtain at least one fusion value for that vector. The fusion value is compared with a predetermined threshold value to thereby measure the likeness of the at least one object relative to the known object or class of objects.

A brief overview of the present invention is as follows. The present invention is directed to an object recognition system that compares a given set of data objects to a selected model object to determine a best match. Data describing the data objects are input through various sensors. A multiple set of data objects form a candidate pool where a match may be found. The number of data objects in the set are reduced in number through a reduction process referred to as Object Reduction. The data objects are denoted by the symbol o_{Di}, where “i” represents the iₜₕ object.

Sensor data is transformed by extracting features such as color, shape, size, signal duration and other such features from the object. Once extracted, the number of features is reduced to include only the significant features. Significant features refer to those features which best describe the object. A process commonly known as feature reduction, (e.g., Principal Component Analysis) is used to determine which features are significant, i.e., those features which are statistically relevant. After reducing the number of features, scores are assigned to each feature based on a Target Object denoted by oₘ, where “m” stands for the modeled object. The model object may be either a single object (for single object mode) or a group of objects (for group object mode). Scores are achieved by comparing the model object to each data object, scores are denoted by Sⱼ^{k}, which reads the j^{th} feature score for the k^{th} data object. The system herein compares a given set of Data Objects o_{Di} to a selected model object oₘ, to determine a best match. A best match is determined using a process that assigns and selects the best score that is given to various object features like “image profiles,” “object color,” and “object temporal information.” Scores are based on how closely they compare to the Model Object. Scores are derived from Fuzzy methods, distance measurements, and image space correlation.

Object matching from score results are achieved by first training a Model Object using a special training approach which allows for small training data sets and quick on-line training methods. The training approach uses an Evolution Based Training Algorithm to determine optimal weight patterns, or weight vectors, to prioritize features in the matching object. Scores are derived by applying the weighted vectors to the feature values of random objects. This technique allows for quick on-line training of the Scores which are then fused together into the resulting confidence level. Objects are then identified using a voting scheme by which confidence levels are used in the primary decision.

Those skilled in the art will recognize that the term “object” pertains to speech or other audio signals, seismic data, sonar data, electrical waveforms, and other electromagnetic signals, such as radar signals. The term object also pertains to image sensor data corresponding to text, optical symbols, and images of objects, such as persons, vehicles, or other things. Object recognition, as used herein, may also be applied to applications relating to personal identification, such as in iris pattern recognition, retinal pattern recognition, facial feature recognition, finger prints, or other such applications.

As embodied herein, and depicted in FIG. 1, a high level block diagram of the system 10 of the present invention is shown. System 10 includes at least one computer system 20 which is configured to execute the instructions of recognition module 30. System 10 also includes a tracking module 40 and a user interface 12. Computer system 20 is coupled to at least one sensor 14 which detects and surveils objects in an area of interest. If recognition module 30 decides that an object being surveilled matches a known object, tracking module 40 will search the database for common occurrences to thereby track the object. Under certain circumstances, if recognition module 30 decides that the object being surveilled matches a known type of object that is of interest, according to predetermined criteria, the object will be stored in the database for later reference by tracking module 40.

As embodied herein, and depicted in FIG. 2, a hardware diagram of system 10 in accordance with one embodiment the present invention is disclosed. System 10 includes computer system 20 coupled to host computer 220, databases 50, and user display and control system 12, by way of network(s) 16. Host computer 220 is coupled to area surveillance sensor(s) 14. Computer 20 may interface the various databases 50 from network 16. User interface 12, which consists of a display and various data input means, may access computer 20 by way of network 16.

Network 16 may be any type of network including, but not limited to, a local area network (LAN), a wide area network (WAN), the public switched telephone network (PSTN), the global packet data communication network now commonly referred to as the “Internet,” any wireless network, or to data equipment operated by a service provider. Network 16 may a combination of the above listed networks. Network 16 may employ electrical, electromagnetic, or optical signals to transmit data and instructions.

User display and control system 12 may be a networked personal computer or a workstation. System 12 includes a display, a cursor control device, and an input device. The display may include a cathode ray tube (CRT), a liquid crystal display, an active e matrix display, or a plasma display. Those of ordinary skill in the art will recognize that input device may be of any suitable type, such as a keyboard that includes alphanumeric and other keys. Input device is employed by a user to communicate information and command selections to the processor in the computer. The cursor control mechanism may include a mouse, a trackball, or cursor direction keys.

Computer 20 includes random access memory (RAM ) 200, read only memory (ROM) 202, memory storages devices 204, I/O facility 206, processor 208, and communications interface 210, all coupled together by bus system 212. As shown, the recognition module 30 and tracking module 40 are software programs which reside in ROM 202.

Random access memory (RAM) 200 is used to store data and instructions that are executed by processor 208. RAM 200 may also be used for storing temporary variables or other intermediate information during execution of instructions by the processor 208. Read only memory (ROM) 202, or some other static storage device, is configured to store static information and instructions for use by processor 208. When a portion of the code is to be executed, it is retrieved from ROM 202 and written into an appropriate register in RAM 200. Storage device 204 may be of any suitable type of media and is used for long-term storage of data, instructions, and/or applications. Storage device 204 may include a hard disk, or other magnetic media, or optically read media. Computer system 20 may also be coupled via bus 212 to a display, input device, and/or a cursor control device by way of I/O circuit 206.

As noted above, the recognition module 30 and the tracking module 40 may reside in ROM 202 and be executed by processor 208. Recognition module 30 and tracking module include an arrangement of instructions. These instructions are typically read into RAM 200 from ROM 202, but can be read from another computer-readable medium, such as the storage device 204, or by some external source such as database 50. Execution of the arrangement of instructions contained in RAM 200 causes processor 208 to perform the process steps described herein. It will be apparent to those of ordinary skill in the pertinent art that modifications and variations can be made to processor 208 of the present invention depending on cost, speed and timing, and other design considerations. For example, processor 208 may be implemented using a processor of the type manufactured by Intel, AMD, Motorola, or by other manufacturer's of comparable devices. Processor 208 may also include a reduced instruction set (RISC) processor or an application specific integrated circuit (ASIC). In alternative embodiments, hard-wired circuitry may be used in place of or in combination with software instructions to implement the embodiment of the present invention. Thus, the implementation of the present invention is not limited to any specific combination of hardware circuitry and software.

As shown in FIG. 2, computer system 20 also includes communication interface 210 coupled to bus 212. Communication interface 210 provides a two-way data communication coupling to a network 16. In the embodiment shown, communication interface 210 may include a local area network (LAN) card (e.g. for Ethemet™ or an Asynchronous Transfer Model (ATM) network) to provide a compatible data communication connection to network 16. However, those of ordinary skill in the art will recognize that interface 210 is not limited to the embodiment shown in FIG. 2. Communication interface 210 may also include a digital subscriber line (DSL) card or modem, an integrated services digital network (ISDN) card, a cable modem, a telephone modem, or any other communication interface to provide a data communication connection to a corresponding type of communication line. Wireless links can also be implemented. In any such implementation, communication interface 210 sends and receives electrical, electromagnetic, or optical signals that carry digital data representing various types of information. Further, the communication interface 210 may include peripheral interface devices, such as a Universal Serial Bus (USB) interface, a PCMCIA (Personal Computer Memory Card International Association) interface, and etc. Although a single communication interface 210 is depicted in FIG. 2, interface 210 may include multiple communication interfaces. As stated above, the computer system 20 includes at least one computer readable medium or memory for holding instructions programmed according to the teachings of the invention and for containing data structures, tables, records, or other data described herein. Common forms of computer-readable media include RAM, ROM, PROM, EPROM, FLASH-EPROM, E²PROM, and/or any other memory chip or cartridge. Computer-readable media may also include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia. Computer readable medium also may include a carrier wave, or any other medium from which a computer can read.

Transmission media may include coaxial cables, copper wires, fiber optics, printed circuit board traces and drivers, such as those used to implement the computer system bus. Transmission media can also take the form of optical, or electromagnetic waves, such as those generated during radio frequency (RF) and infrared (IR) data communications.

Sensors 14 as defined by the invention may be of any suitable type, including any sensor device suitable for capturing speech or other audio signals, seismic data, sonar data, electrical waveforms, and other electromagnetic signals, such as radar signals. The term “sensor” also pertains to imaging devices that are configured to capture text, optical symbols, and images of objects, such as persons, vehicles, or other such things.

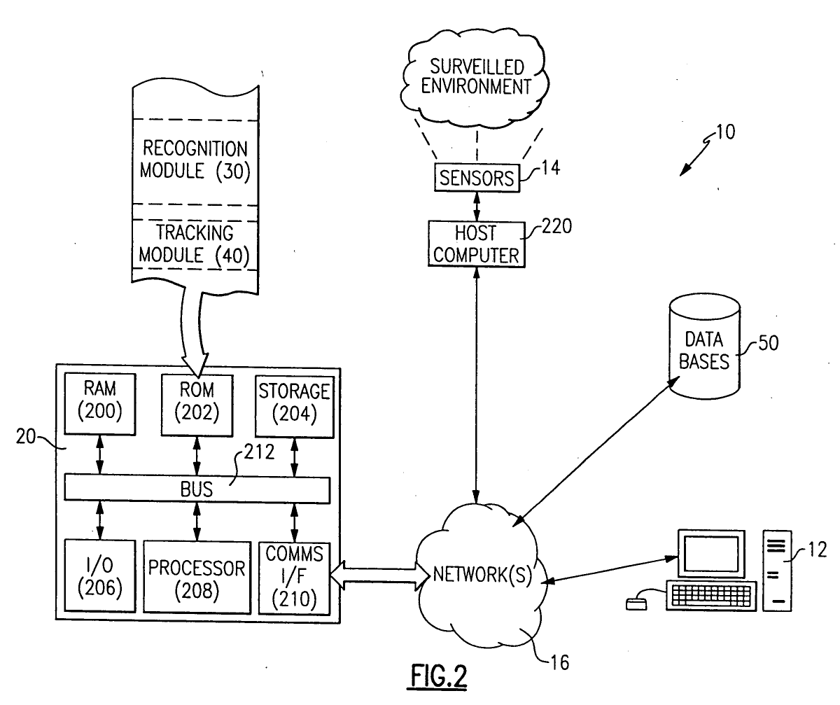

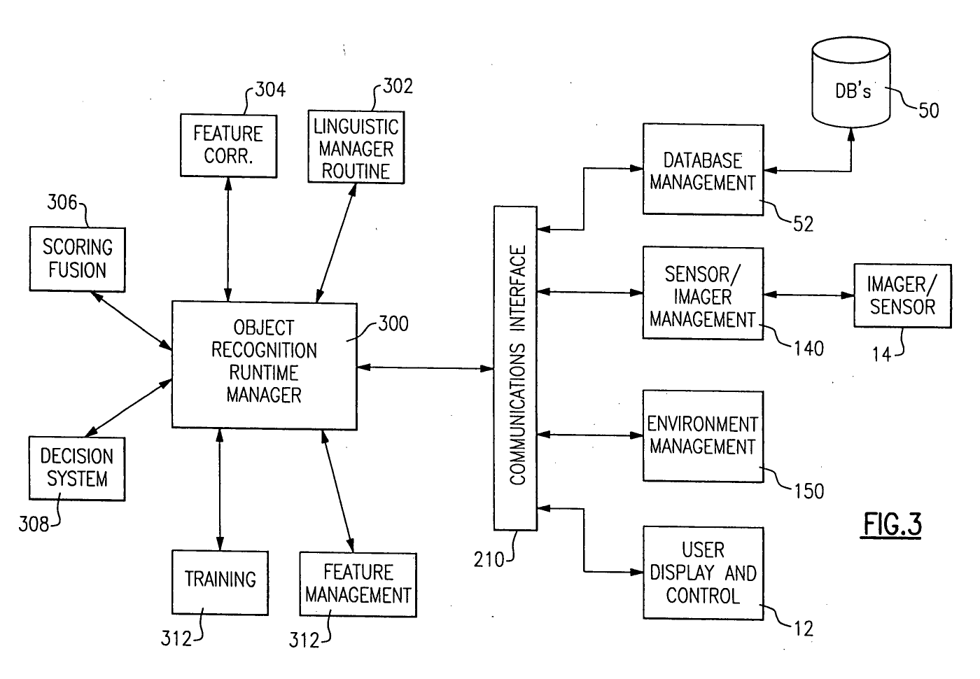

As embodied herein and depicted in FIG. 3, the functional block diagram of the system of the present invention is shown. Recognition module 30 includes an object recognition run time manager 300 which calls various programs and routines as needed. These routines include a linguistic manager routine 302, a feature correlation routine 304, a scoring fusion routine 306, and a decision routine 308. The object recognition runtime manager 300 is also coupled to training module 310 and a feature management routines 312. The object recognition runtime manager 300 is coupled to external devices by way of communications interface 210. The communications interface 210 is coupled to the database management module 52, the sensor manager 140, the environmental manager 150 and the user display and control unit 12. The sensor manager 140 is coupled to the imager or the sensor 14. Likewise, the database manager 52 is coupled to the various databases 50.

As will be discussed below, feature management is grouped into two categories, “automated” and “manual” features. Features are distributed to a number of software routines, and feature management generally refers to the process of defining the important features for each object being monitored or tracked. Initially, for automated features, a user provides a configuration file that includes rules that help define the type of data that being recognized. For a human face object, that may include algorithms that locate certain facial features such as eye, nose and mouth locations. For an automobile that may include algorithms that look for features, such as but not limited to headlights, grill and windshield coordinates. The previously mentioned algorithms are considered generalized search routines where by the user would specify “automobile” or “human face” as an option to start the recognition process. Based on the object type, a set of automated features can then be extracted. These automated features can include, but are not limited to, edge characteristics, signature characteristics, color contrast characteristics, gradient intensity information, correlation to deformable geometric patterns and the like. The user can also specify “manual” features by selecting portions of the matching object. Therefore, various pattern matching scenarios can exist for a given matching object. For example, automatic features can be generated to search for a automobile of model jeep. The user can further select a location on a specific jeep that has a sticker or other unique identification mark. For each matching scenario, features are ranked in order of importance by optimizing weighting coefficients through application of the Evolution Based Trainer. The user also has the option to prioritize the manual features higher than the automated ones, if no priority is set then the Evolution Trainer will assign one based on fitness criteria derived from the training database.

With respect to the above described software programs and/or routines, those of ordinary skill in the art will understand that any suitable programming language may be employed to produce these software elements, but by way of example, the present invention has been written using C or C⁺⁺.

The sensor manager 140 is comprised of both software and hardware elements. The environment manager 150, likewise, is comprised of hardware and software elements and it may include a card that plugs into the back plane of the host computer. The environmental manager 150 may include light sensors, temperature sensors and precipitation sensors and when an image of an object is captured the environmental manager will record the ambient condition, such as the lighting, temperature and precipitation.

User interface 12 allows a user to select region of interest areas to be studied and describe the type of search that will be performed. For example, the user may be interested in finding all cars made by Honda between 1990 and 1995. This user specified data is employed by the recognition module 30 to limit the search made in databases 50.

Referring back to the software modules and programs described above, the feature correlator 304, the feature fusion module 306, the likelihood module 308, the training module 310 and the feature management module 312 will be described in detail below.

Referring to the linguistic manager routine, much of the user-defined input is provided in a human readable or human understandable format. The linguistic manager converts human readable information into machine readable data that is more readily used by module 30. For example, a phrase such as a “light red car” is converted into numerical values recognized by the software. First, the phrase is parsed, and each term is assigned a value. For example, the hue, chroma, luminance, and saturation of a given color are easily quantified. Similarly, terms like “big” and “small” in relation to a class of objects, such as people, automobiles, and/or other such tangible objects, may be dimensionally quantified.

Referring to FIG. 4, recognition mode selection unit 320 is shown. A user, by way of operator display and control unit 12, can select one of three modes. The first mode is the template training mode 310. The user can also select a group recognition mode 600 which tries to match an object detected by the imager or the sensor with a class of objects. For example, group recognition mode 600 is configured to determine if an object is a certain type of vehicle, such as a Ford Explorer. The third mode is the unique object recognition mode 800. In this mode, the user seeks to match a detected object with a unique object stored in the database. For example, the object captured by the sensor 14 is compared to a unique Ford Explorer stored in object database 520. A “trained template” includes many aspects required for recognition. To manage this, a list of features are defined by the feature management software which includes region of interest rules, feature extraction guidelines; and weight values assigned to the various features. The description of the template is therefore determined by the type of search (group/individual), region of interest rules, and feature list values.

### Search Mode: Individual or Group Search

The recognition mode selector 320 operates as follows. If the user wants to search for a class of objects not included in the template database 510 (e.g., Honda Civics), then a training mode is invoked using groups of objects as the truth values. This training criteria can include, but not limited to, actual images of the object, CAD drawings of the object or other subsequent data pertaining to the object to be matched. Subsequently, an on-line (or off-line) training session occurs and a “trained template” is constructed that best matches the search criteria provided by the user. The template is then stored in database 510. Once the template is constructed, the user invokes the template recognition mode 600 to perform the search using the template. If the template was trained before the query, then the training mode 310 is not invoked. If the user wants to search for a unique object, (i.e. a particular vehicle) then the unique object recognition mode 800 is invoked using at least one individual object of the type of object that is being searched for (i.e. jeep with a sticker on its hood). Similar to group mode, the training criteria can include CAD drawings of the object but more importantly user defined ROI features that help distinguish the object as an “individual object” aside from the group. Subsequently, an on-line (or off-line) training session occurs and a “trained template” is constructed that best matches the search criteria provided by the user. The template may be stored in database 510 or discarded after use.

### Training Module Overview

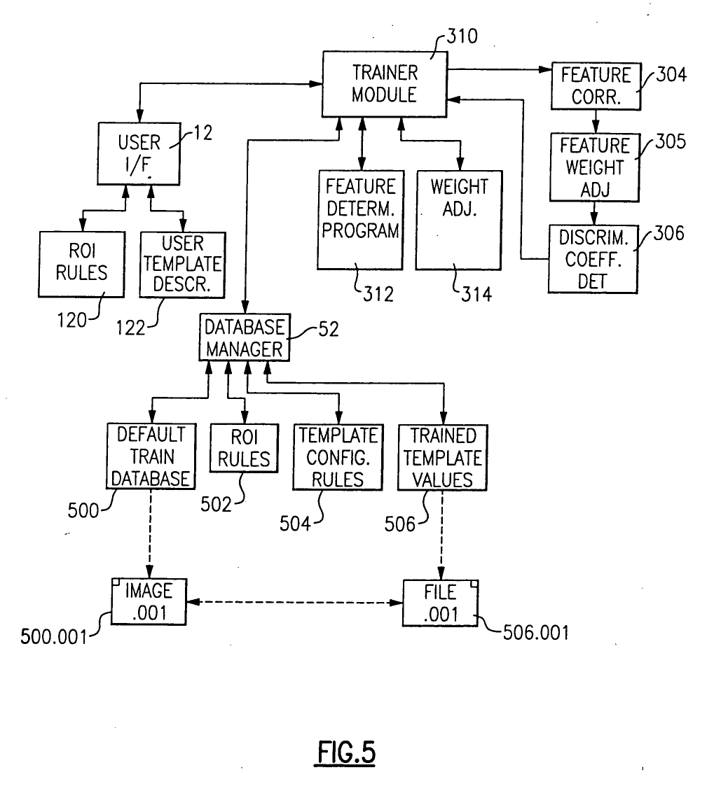

As embodied herein and depicted in FIG. 5, a functional block diagram of the template training module 310 is shown. The training module 310 is coupled to user interface 12. The user provides the training module with region of interest rules and a user template description 122. The user template description 122 may include a description of, for example, 1995 Honda Civics, whereas the region of interest rules will describe certain aspects of the 1995 Honda Civic such grill configuration details, headlight details, significant distance parameters, windshield location and size or other such information. The template description can also be extended to individual mode searches whereby the user can include Specific ROI locations to be searched, specific colors, and other such distinguishing features.

The trainer module 310 is also coupled to database manager 52. In the training mode, database manager 52 is coupled to the default training database 500, the region of interest rules database 502, the template configuration rules database 504 and a trained template values database 506. Each image file (500.001) in database 500 corresponds to a trained template file (506.001). In other words, file 506.001 functions as a “truth value,” in that the training module 310 knows that file 506.001 includes appropriate features and optimized feature weights. The training module is also coupled to a feature determination program 312, a weight adjustment program 314 and a feature correlator program 304. The feature correlator program 304, in turn, is coupled to feature weight adjustment program 305 and discrimination coefficient determination program 306. The discrimination coefficient determination program 306 provides an output to trainer module 310.

The default training base 500 provides an image that defines a class of objects, such as a Honda Civic for a given model year. The template configuration rules database determines what features should be examined or analyzed. The trained template value database 506 includes a known trained template for the Honda Civic retrieved from database 500, and provides a comparison for template training. During operation, image features from the default training database 500 and the region of interest rules and the template configuration rules database 504 are passed to the object runtime module 310. In parallel, the region of interest rules from the user, and a description of the user template, are also loaded to the object recognition runtime kernel. The object trainer module 310 receives the user data, the training features, and the default template rules from the databases, and passes this data to the feature determination program 312.

The feature determination program 312 analyzes the training object and determines nominal feature values that are used later to “mine” objects from the database. (i.e. vehicle width and height can be used to separate objects based on size). Feature mining determines those features that are most important in describing an object. Those features which are incidental are eliminated during the mining process. Mining reduces the training set and generates a smaller candidate of possible image templates. Each candidate image is described by a vector that includes a finite string of feature elements. Each feature element is modified by a weighting coefficient. As noted, the weighting coefficient may be adjusted in module 314 to account for environmental data. Subsequently, the trainer module 310 provides feature correlator with a truth value and the set of vectors describing the image candidates.

In feature weight adjustment module 305, the weights of all the candidates are adjusted using a genetic algorithm which optimizes the coefficients. Ultimately the truth value and the candidate image vectors are fused and a discrimination coefficient is generated. The discrimination coefficient is then passed back to the trainer module 310, and if it is not acceptable the process repeats until the maximum discrimination between training object and other objects is achieved. In cases where an acceptable score is not achieved, the user is then required to add additional features to the matching criteria. Otherwise, the identification of false positives objects may result.

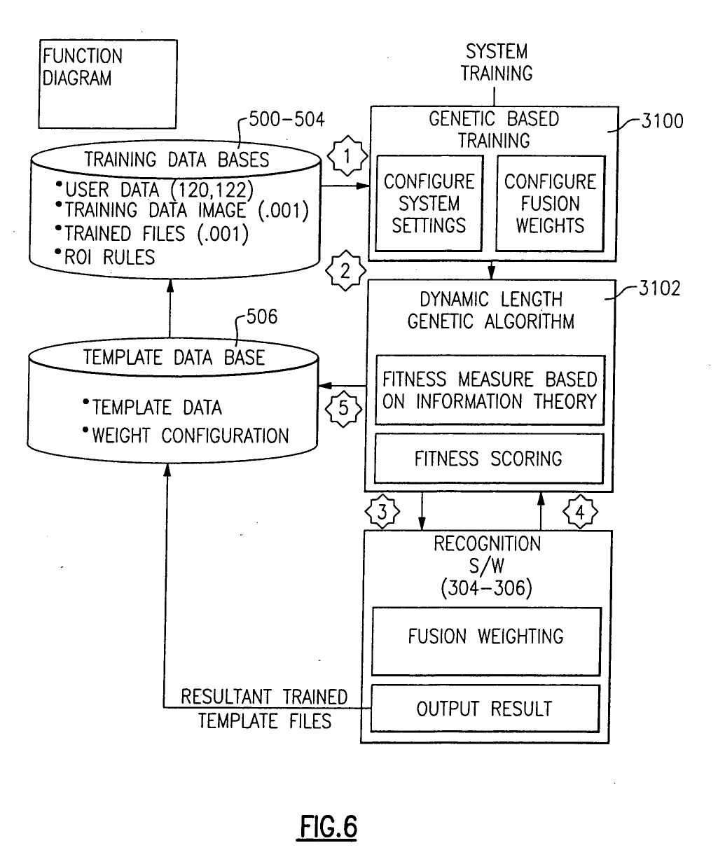

The discrimination coefficient is a fitness measure of how different a candidate object is from the “truth objects,” i.e., objects that are known to be of a certain type. During a training scenario, the objective is to create the largest possible discrimination coefficient, rather maximize the discrimination between modeled truth objects and those objects belonging to another class. Once the maximum acceptable discrimination coefficient is found, the corresponding candidate image is stored in a template database along with the optimized template weights. FIG. 6 is a functional diagram of the training module shown in FIG. 5. As shown, user data, ROI rules, training data images and their corresponding trained templates, are provided to system configuration module 3100. The trained template, of course, is obtained from database 506. Configuration module 3100 configures system settings and determines the features and the initial fusion weights to thereby formulate a “population.” The population is provided to genetic algorithm module 3102.

A genetic algorithm is an optimization process which is particularly useful, but not limited to, problems that are non-linear in nature. Genetic optimization creates a population of members known as the genome. Each member in the population is identified by their unique chromosome structure. Each individual is represented by a finite string of symbols. The symbols may be in binary or in hexadecimal format. In the present application, the individual's chromosome structure in the genome corresponds to optimal feature weight elements, or feature weight vectors. Since the user can select additional features, chromosome length will vary depending on the search criteria. This variation requires added features to be decoded in the chromosome. Hence, the Genetic Algorithm of the present invention “trains” using a dynamic length chromosome, where the length of chromosome is fixed for the given search/training, but can vary in length from search to search depending on whether or not the user selects additional criteria to search on (i.e. sticker on the jeep vehicle would require a longer chromosome). Typically, a genetic algorithm is applied to spaces which are too large to be exhaustively searched and/or spaces which are non-continuous and require non-linear optimization methods.

As noted above, an initial population of individuals is generated using a configuration file that includes automated region of interest (ROI) data, user defined features, and a feature list (this applies for group and individual search modes). The values of the feature elements, or individuals, may be generated randomly or heuristically by the user, however these rules are stored within the feature list. As shown in step 3 and step 4, at every evolutionary step, known as a generation, the individuals in the current population are decoded and evaluated according to some predefined quality criterion, referred to as the fitness, or fitness function. In the present application, the predefined quality criterion is obtained from the trained template file. To form a new population (the next generation), individuals are selected according to their fitness. The fitness is determined by the discrimination coefficient which is a value to be optimized. Thus, in FIG. 5, the discrimination coefficient is passed back to trainer module 510 for evaluation. If the coefficient is not sufficiently large the process continues until the genome, or template, is considered “fit.” In step 5, the “fit” template, or trained template, is stored as a trained template file in database 506. The image corresponding to the trained file is stored in database 500. The image and the trained file are linked.

A measure of “best” or optimal training is determined through a information based fitness relation given as:

$${{𝔍}_{fitness} ( C )}^{*} = E [ \frac{- ln ( 1 / F ( {s}_{ \overline{M}} )}{- ln ( 1 / F ( {s}_{M} )} ] - α / {N}_{c} \qquad ( 1 )$$

in which,
F(s_{\overline{M}})—Fusion values of objects not belonging to the matching object.
F(s_{M})—Fusion values that belong to the matching class object or individual object
α—Penalty Constant;
N_{C}—Number of Objects in the training set; and
E represents the expected value operator.

The penalty constant is a calibration value that is selected based on the number of objects in the training set. The penalty constant is selected to provide distance separation referred to herein as the discrimination coefficient. The discrimination coefficient measures between those training sets that are deemed unfit, and those which are “fit” by evaluating the ratio of objects that belong in the class to those objects that do not belong on the class.

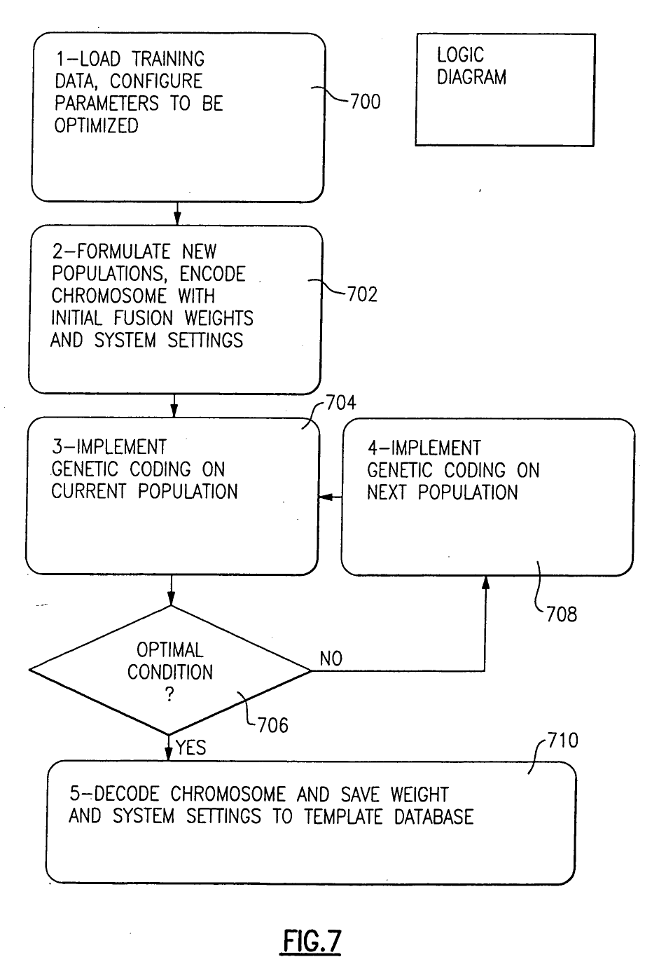

FIG. 7 is a flow diagram showing the method for training a template described in FIG. 6. In step 700, all of the training data and images are loaded. The features, e.g. parameters, that best represent the image are determined and configured in the finite string, as discussed above. In step 702, new populations are formulated. Each chromosome (feature) in the genome (reference vector) is encoded with an initial fusion weight and system setting value; the length of the chromosome is determined based on the number of features used in the given search. In steps 704 and 706, the chromosomes, or individuals, in the current populations are decoded and evaluated according to the fitness function. Chromosomes that are more fit are used in a population reproduction process. New genes are added to the pool by mutating randomly selected chromosomes. Together both selected and newly mutated chromosomes are created and added to the population. A new iteration of selecting the “fittest” set of chromosome is performed, whereby reproduction, selection and mutation are done for future generations. For each generation, all chromosomes (or feature weights) are tried in the matching process and discriminant coefficient scores are generated from the fitness function. Optimal fitness scores will meet a set of termination criteria and terminate the training process. Once a termination criteria has been met the optimal chromosome is converted into feature weights and saved within the template along with ROI rules and feature lists.). Optimized weights and system settings are stored as a “trained” template file in database 506.

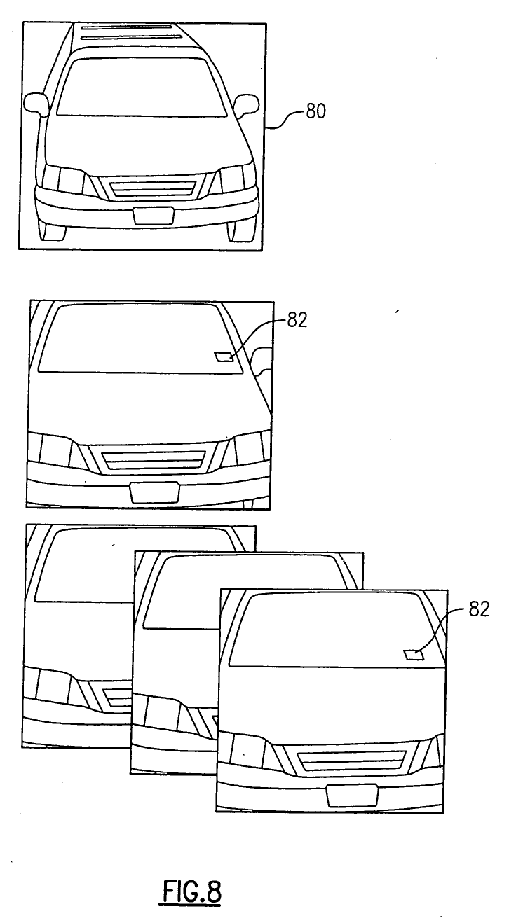

Referring to FIG. 8, examples of training inputs to the training module are provided. The evolution based training module of the present invention is configured to use CAD object 80 for training and template creation. On the other hand, an individual object 82, or a group of objects 84 may be employed by the training module to train and create a template.

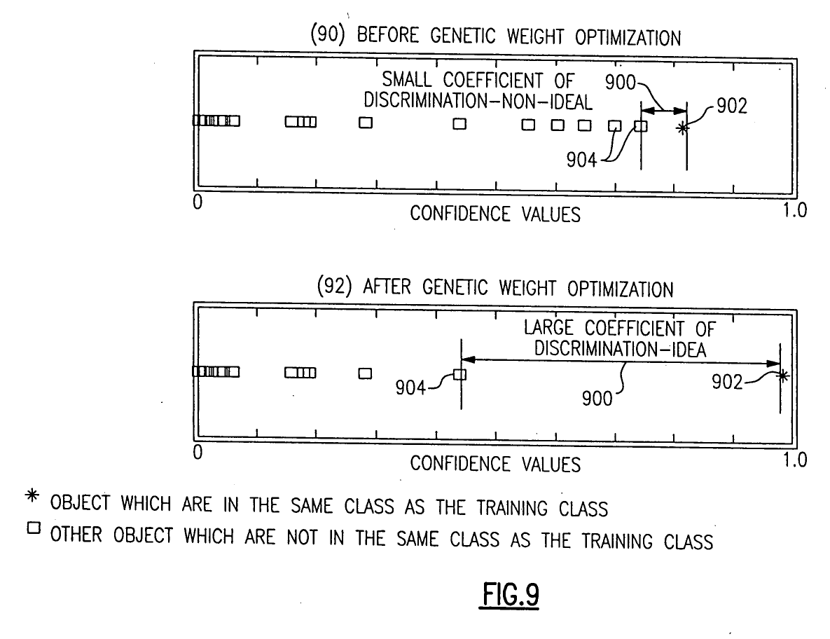

FIG. 9 is a diagram illustrating genetic weight optimization and the concept of a discrimination coefficient. Graph 90 shows a series of objects plotted on a line over a range that is between zero and one. One object 902 represents an exact match. A value of 0.9 represents a 90% “confidence” that the object matches a truth object. In this case, asterisk 902 represents an object that is of the same type as that of the training class. For example, the training class may be “Ford Explorers.” Thus, object 902 is a Ford Explorer. However, it is apparent that the template is not optimized because object 902 should be very close to one (1.0). Further, the coefficient of discrimination 900, i.e., the distance from the known object 902 to the closest object 904 is less than 0.1. This is problematic because object 904 is not in the same class as the training class. For example, object 904 may represent a Jeep. At this point, the training template is configured to adjust the weighting coefficients in the manner described above until the coefficients are optimized.

Graph 92 shows the result of the optimization process. As noted above, object 902 represents a Ford Explorer, an object that is of the same type as that of the training class. After optimization, it is very close to one (1.0). Further, the next closest object, Jeep 904, which is not in the same class, has a confidence value of approximately 44%, which is expected since it is not in the same class of objects. Significantly, the coefficient of discrimination has increased five-fold to over 0.5.

### Data Acquisition Mode

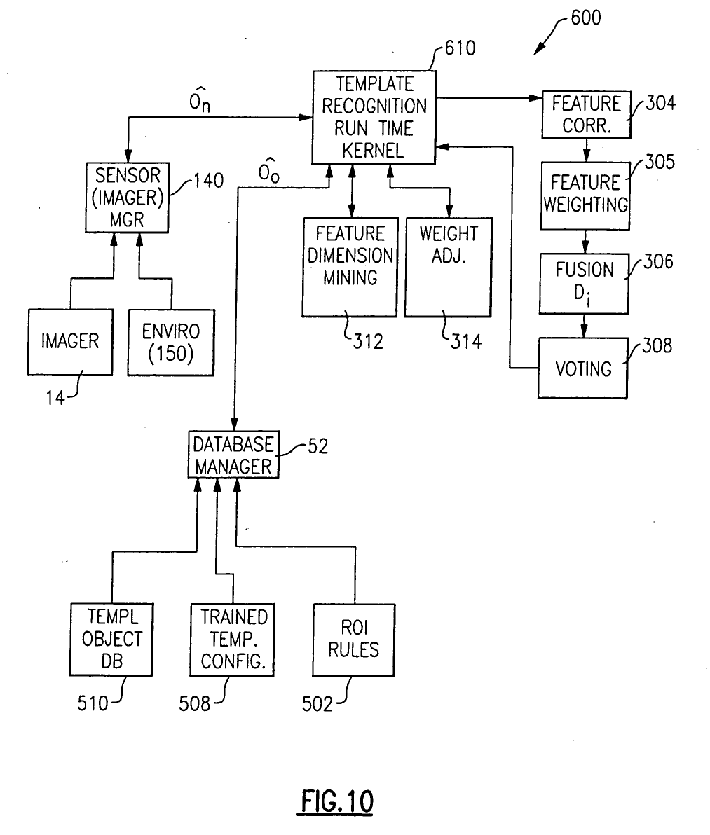

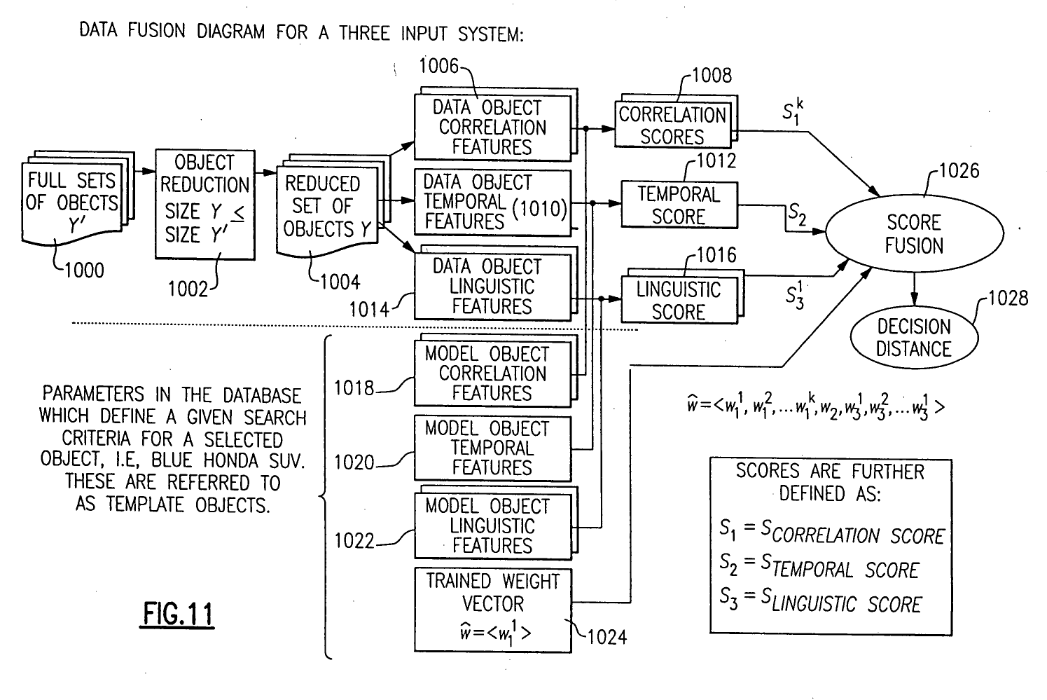

Prior to a user selecting a recognition query, the system first senses and stores objects for comparison. Depicted in FIG. 10, Sensor Image Manager 140 retrieves images via 14 and environmental information (such as time of day, lighting and other sensory data) via 150. The sensor manager is coupled to the sensor 14 and the environmental manager 150. The sensor is configured to detect an unknown object and store the objects image into the Database through the Database manager 52. During the storage process, information specific to mining the data is also stored, this data includes but not limited to Object physical location, object time of acquisition, object size and other data useful in reducing the search space during the Recognition Mode. Database manager 52 is also responsible memory and storage management for images.

### Group and Individual Recognition Module

As embodied herein and depicted in FIG. 10, the Group/Individual recognition module 600 is shown. In Group mode, the user selects the type of group that is to be searched and submits the query to the Runtime Kernel 610. Consider the query Jeep Trucks. The sensor imager manager 140 provides template recognition runtime kernel 610 with a trained template specific to the user query, if a template does not exist then the user is notified that an on-line training mode must first be initiated (see prior section for training an object template). The database manager 52 then receives the template reference vector from trained template configuration database 508. Database manager 52 uses the template to process region of interest rules (ROI rules) and a feature extraction plan from the template. Next, the recognition runtime kernel provides the database manager with a feature extraction plan and ROI rules, which was derived from the trained template. Features are extracted as the unknown objects are retrieved from the database using various mining scenarios which include object size, sensed time, object location object color and other parameters that are useful in reducing the search data. Feature coefficients for the unknown objects are stored in data reference vectors (O_{Di}). Database manager 52 also provides reference vector (specific to Jeep Vehicles) denoted as (O_{M}) to the runtime kernel 610. The runtime kernel will then use (O_{M}) and each occurrence of (O_{Di}) for comparison matching.

The template recognition runtime kernel is also coupled to feature dimension mining program 312 and weight adjustment program 314. The feature determination program 312 “mines” both object vector and the reference vector to include the most relevant feature elements as they are retrieved from the database manager. Database manager 52 passes a list of database candidates to the runtime kernel 610. Feature dimension mining module 312 mines this list of database candidates to thereby produce a more limited list of database feature candidates. These are passed to the weight adjustment module 314. The weight adjustment module 314 uses weights from (O_{M}), which were the result of the genetic optimization algorithm, to adjust the feature magnitudes of the mined feature list to thereby produce a list of candidates that match the template.

Template recognition runtime kernel transmits the object vector and the reference vector to feature correlator 304. After these vectors are correlated, they are transmitted to feature weighting module 305. Subsequently, the two vectors are fused to produce a confidence value ranging between 0 and 1. Confidences closer to 1 are identified as a match, where confidences near 0 are non-matching objects. The confidence value is transmitted to likelihood module 308. As noted above, the confidence values ranges in value from zero to one and the likelihood module compares the values to a threshold level. If the confidence is greater than the threshold value, likelihood module determines that the object is a member of the class represented by the reference vector. If the confidence is below the threshold, then likelihood module 308 determines that there is no match.

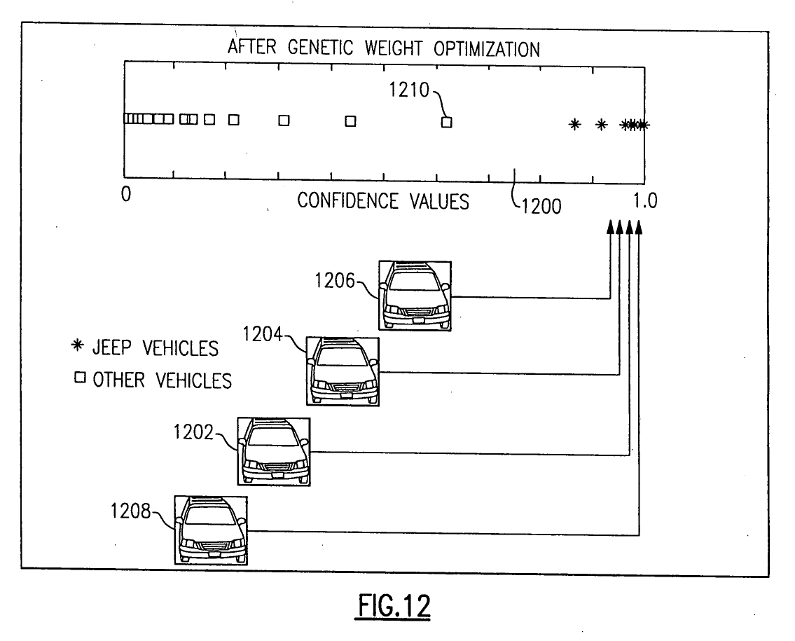

As embodied herein and depicted in FIG. 11, a flow diagram showing the data fusion process used in FIG. 8 is disclosed. In step 1000, a full set of objects, in the case, a set of images of cars obtained from a sensor(s) is provided to system 10. As an initial processing step, the set of objects is reduced to a more manageable number by applying Tchebysheff's Theorem. Tchebysheff's Theorem provides upper boundary (2) for this mining criterion to be:

$$P ( \vert {Y}_{t} - {μ}_{t} \vert < k {σ}_{i} ) \geq 1 - \frac{1}{{k}^{2}} \qquad ( 2 )$$

Where,
i—is the ith feature dimension to be reduced.
σ—the standard deviation of the given feature dimension
μ—the mean value for the given feature dimension
k—is the proportionality constant to which the limits for reduction are defined.

Those objects that falls with in the boundaries are included in the reduced set of objects Y. The set of Y values for mining may contain but is not limited to the object sense time, object size, object color values or other features to which general statistics of mean and standard deviation apply.

In step 1008, the data object features are correlated with the model object features. In other words, the features obtained from the reduced data set Y, i.e., features derived from a sensor, are compared with a known object selected from the system databases. In this example, the system is attempting to find a Blue Honda SUV in the reduced set of Objects. Given a model vector of known type denoted by <o_{M}>, and data vectors of unknown object type denoted by <o_{Di}>, the correlation process is as follows:

$${r}_{MD} ( l ) = {\sum }_{n} {o}_{M} ( n + 1 ) {o}_{Di} ( n ) \\ l = 0 , \pm 1 , \pm 2 , … N \qquad ( 3 )$$

The correlation score becomes a normalized value given as:

$${S}_{CorrelationScore} ( l ) = \frac{{r}_{MDi} ( l )}{\sqrt{{r}_{MM} ( 0 ) {r ( 0 )}_{DiDi}}} \qquad ( 4 )$$

Where the absolute value meets the following criteria, rather the score is always less than zero, a perfect score will be exactly zero.
S_{CorrelationScore}=|S_{CorrelationScore}(l)|≦1 (5)

In step 1016, a linguistic score is obtained. Linguistic scoring is derived from the combining of membership values. Memberships are defined through various simplified mathematical models, color for example is described by color shade and color intensity, i.e. light red versus dark red. The relation is given as:
μ_{C}_{_{Intensity}}_{C}_{_{Shade}}(x_{Hue},y_{Saturation},z_{Value})∝[ColorShade(i),ColorIntensity(j)] (6)

Or in short notation,
μ_{C}_{_{I}}_{C}_{_{S}}(x_{H},y_{S},z_{V})=μ_{C}_{_{Intensity}}_{C}_{_{Shade}}(x_{Hue},y_{Saturation},z_{Value}) (7)

This invention uses a Mamdani Min Operator to combine the Fuzzy membership grades, along with a Center of Gravity Defuzzification process. Evaluating across “i” possible combinations, This relation is given as:

$$R ( {x}_{H} , {y}_{S} , {z}_{V} ) = {\sum }_{i} {μ}_{{C}_{t} {C}_{s}} ( i ) ( {x}_{H} {y}_{S} {z}_{V} ) / {x}_{H} {y}_{S} {z}_{V} \qquad ( 8 )$$

In which a score is defined through
S_{Linguistic}=MAX|R(xᵢyⱼ|≦1 (9)

In step 1012, temporal scoring is performed. Temporal scoring is used to compare time relationships between Data Objects and Model Objects. This metric is used to balance recognition performance and processing time. Temporal score is given using the following routine:
S_{Temporal}=1−ΔT/C (10)
ΔT=|T_{ModelObject}−T_{DataObject}| (11)

in which C is a scaling constant and the overall score follows:
|S_{Temporal}|≦1 (12)

In step 1026, the trained weight vector, correlation score 1008, temporal score 1012, linguistic score 1016 are fused. The fusion relation is the combining of the various scores along with weights determined by:

$$F ( {s}_{i} ) = \frac{\begin{matrix}{w}_{1}^{1} {s}_{1}^{1} + {w}_{1}^{2} {s}_{1}^{2} … {w}_{1}^{k} {s}_{1}^{k} + {w}_{2} {s}_{2} + \\ {w}_{3}^{1} {s}_{3}^{1} + {w}_{3}^{2} {s}_{3}^{2} + … + {w}_{3}^{l} {s}_{3}^{l}\end{matrix}}{MAX [ F ( {s}_{t} ) ]} \qquad ( 13 )$$

The largest maximum value is from the Model object denoted by sᵢ and all objects in the set of sᵢ are compared accordingly. The final decision metric may be one of many commonly used, Linear Distance is described below:
1−F(sᵢ)≦β_{ThreshHold} (14)

The linear distance is a projection from a logarithmic curve. As noted above, the closer the value is to one, the better the object matches the model.

FIG. 12 is a diagram showing a pattern match example. In this example, a user queries the system to find the “Jeeps” that are stored in the database. Standard region of interest (ROI) rules are employed. In other words, Jeeps have standard dimensions such as height, width, distance between headlights, grill dimensions, and etc. After optimization, four Jeeps having a confidence value greater than 0.95 or 95% are discovered. The next closest object 1210, non-Jeep vehicle has a confidence value of approximately 62%. Thus, the present invention is configured to search the database to find all objects that are in a predetermined class.

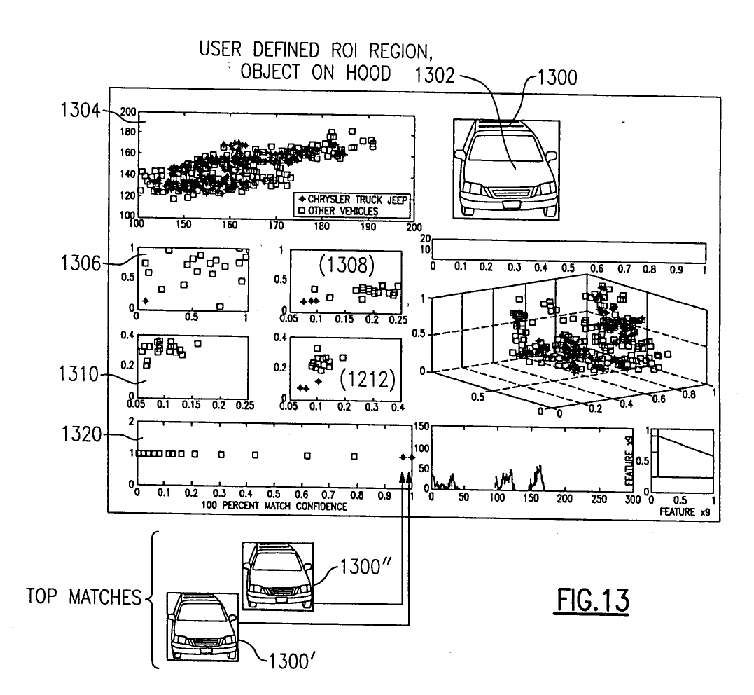

FIG. 13 is a diagram showing a graphical user interface during an individual match scenario. In this case, user defined ROIs may be used in addition to standard ROIs. In this case, the search is for a specific Jeep 1300. Plot 1304 represents raw data obtained from a surveilled region over a period of time. The horizontal axis and the vertical axis correspond to predetermined features, such as the width and height dimensions, respectively. Plot 1306, plot 1308, plot 131 0, and plot 1312 represent mined feature data plots. In other words, Tchebysheff's Theorem was applied to the data set depicted in plot 1302 to thereby limit the number of candidates. Subsequently, the correlation features, temporal features, and linguistic features of each object are compared to the model object, and a fusion score (FIG. 11) is obtained. Finally, the decision distance for each object is plotted in graph 1320. In this example, two Jeeps 1300′, 1300″, having a confidence value of over 95% are obtained.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. An object recognition system, the system comprising:
at least one database having stored therein a trained reference vector, the trained reference vector including a finite string of weighted reference feature elements optimized using a genetic algorithm, the trained reference vector being optimized relative to a fitness function, the fitness function being an information based function, the trained reference vector corresponding to a known object or class of objects;
a sensor disposed in a surveilled region and configured to generate sensor data corresponding to at least one object disposed in the surveilled region; and
a recognition module coupled to the sensor and the at least one database, the recognition module being configured to generate at least one data object vector from the sensor data, the at least one data object vector corresponding to the at least one object, the recognition module being configured to combine the reference vector with the at least one data object vector to obtain at least one fusion value, the at least one fusion value being compared with a predetermined threshold value to thereby measure the likeness of the at least one object relative to the known object or class of objects.

2. The system of claim 1, wherein the fitness function includes the ratio of fusion deviation of the training data set over a fusion deviation of a previous training data set.

3. The system of claim 2, wherein the fitness function is expressed as:
$${{𝔍}_{fitness} ( C )}^{*} = E [ - \frac{ln ( 1 / F ( {s}_{ \overline{M}} )}{ln ( 1 / F ( {s}_{M} )} ] - α / {N}_{c}$$
wherein F(s_{\overline{M}}) are fusion values of objects not belonging to the matching object; F(s_{M}) are fusion values that belong to the matching class object or individual object;
α is a Penalty Constant;
N_{C} is a Number of Objects in the training set; and
E represents an expected value operator.

4. The system of claim 1, wherein the recognition module is configured to operate in a plurality of modes, the plurality of modes including a group object recognition mode and an individual object recognition mode.

5. The system of claim 1, wherein the at least one database further comprises a training database for storing images, each image corresponding to the known object or class of objects.

6. The system of claim 5, wherein the at least one database includes a trained template database configured to store trained reference vectors, each trained reference vector being linked to a corresponding image in the training database.

7. The system of claim 6, wherein the at least one database includes a template configuration rules database, the template configuration rules database being employed in the training mode.

8. The system of claim 6, wherein the at least one database includes a region of interest database, the region of interest database including region of interest data for a trained reference vector.

9. The system of claim 8, wherein the region of interest data is linked to a corresponding image in the training database.

10. The system of claim 1, further comprising a training module, the training module including a genetic algorithm routine executed in a template training mode.

11. The system of claim 10, wherein the genetic algorithm routine is applied to a population of untrained reference vectors on an iterative basis until the weighted reference feature elements are optimized relative to the fitness function.

12. The system of claim 10, wherein the recognition module and the training module reside on a computer system and are tangibly embodied, at least partially, in a computer readable medium having computer executable instructions disposed thereon.

13. The system of claim 1, wherein each of the at least one data object vectors includes object correlation features, object temporal features, and object linguistic features, and wherein the reference vector includes reference object correlation features, reference object temporal features, and reference object linguistic features.

14. The system of claim 13, wherein the recognition module is configured to correlate the object correlation features with the reference object correlation features to obtain a correlation score, to correlate the object temporal features with the reference object temporal features to obtain a temporal score, and to correlate the object linguistic features with the reference object linguistic features to obtain a linguistic score.

15. The system of claim 14, wherein the recognition module includes a scoring fusion module, the scoring fusion module is configured to fuse the correlation score, the temporal score, and the linguistic score to obtain the fusion value for each of the at least one object vectors.

16. The system of claim 15, wherein the recognition module includes a decision module, the decision module being configured to compare the fusion value to the predetermined threshold value to thereby measure the likeness of the at least one object relative to the known object or class of objects.

17. The system of claim 1, further comprising a user interface configured to provide the recognition module with user defined input data.

18. The system of claim 17, further comprising a linguistic module configured to translate the user defined input data into machine readable data appropriate for use by the recognition module, the user defined input data corresponding to data object linguistic features.

19. The system of claim 1, further comprising an environmental conditions manager coupled to the recognition module, the environmental conditions manager being configured to provide the recognition module with environmental data corresponding to ambient conditions relative to the at least one object.

20. The system of claim 1, wherein the sensor includes an imaging device configured to capture an image of the at least one object.

21. The system of claim 20, wherein the imaging device captures light characterized by wavelengths in a spectral band that includes visual wavelengths.

22. The system of claim 20, wherein the imaging device captures light characterized by wavelengths in a spectral band that does not include visual wavelengths.

23. The system of claim 22, wherein the spectral band includes infrared wavelengths.

24. The system of claim 22, wherein the spectral band includes x-rays.

25. The system of claim 1, wherein the sensor includes an instrument configured to generate a waveform, the at least one object representing a physical phenomenon.

26. The system of claim 28, wherein the physical phenomenon is an electromagnetic phenomenon.

27. The system of claim 1, wherein the at least one object represents a vehicle.

28. The system of claim 1, wherein the at least one object represents a human being.

29. The system of claim 1, wherein the at least one object represents facial characteristics, iris characteristics, retinal characteristics, and/or finger print characteristics.

30. The system of claim 1, wherein the at least one object includes a plurality of objects.

31. The system of claim 1, further comprising a tracking module coupled to the recognition module, the tracking module being configured to create a tracked data object record if the at least one object matches the known object, and update the tracked data object record each time the at least one object matches the known object.

32. The system of claim 1, wherein reference feature elements may be selected from a group that includes color, size, shape, type, spectral characteristics, frequency characteristics, amplitude characteristics, patterns, and/or sub-feature characteristics.

33. An object recognition system, the system comprising:
at least one database including at least one trained reference vector and at least one training image corresponding to the at least one trained reference vector, each of the at least one trained reference vectors including a plurality of trained model object features optimized using a genetic algorithm, the trained reference vector being optimized relative to a fitness function, the fitness function being an information based function, the trained reference vector corresponding to a known object or class of objects;
a user interface configured to input user specified data into the system;
at least one sensor disposed in a surveilled region and configured to generate sensor data corresponding to at least one object disposed in the surveilled region; and
at least one computer coupled to the at least one sensor, the user interface, and the at least one database, the at least one computer being configured to,
obtain a trained reference vector from the at least one database,
generate at least one data object vector from the sensor data, the data object vector including a plurality of data object features,
compare each data object feature to a corresponding trained model object feature to obtain a plurality of scores, and
combine the plurality of scores to obtain a fusion value, the fusion value representing a measure of the likeness of the at least one object relative to the known object or class of objects.

34. The system of claim 33, wherein the at least one computer is further configured to compare the fusion value with a predetermined threshold value to obtain a decision value, the decision value being a measure of the likeness of the at least one object relative to the known object or class of objects.

35. The system of claim 33, wherein the fitness function is expressed as:
$${{𝔍}_{fitness} ( C )}^{*} = E [ - \frac{ln ( 1 / F ( {s}_{ \overline{M}} )}{ln ( 1 / F ( {s}_{M} )} ] - α / {N}_{c}$$
wherein
F(s_{\overline{M}}) are fusion values of objects not belonging to the matching object;
F(s_{M}) are fusion values that belong to the matching class object or individual object
α is a Penalty Constant;
N_{C} is a Number of Objects in the training set; and
E represents the expected value operator.

36. The system of claim 33, wherein the plurality of data object features include a plurality of data object correlation features, a plurality of data object temporal features, and a plurality of data object linguistic features.

37. The system of claim 36, wherein the at least one computer is configured to compare the plurality of data object correlation features with a corresponding plurality of trained model object correlation features to thereby obtain a correlation score.

38. The system of claim 37, wherein the at least one computer is configured to compare the plurality of data object temporal features with a corresponding plurality of trained model object temporal features to thereby obtain a temporal score.

39. The system of claim 38, wherein the at least one computer is configured to compare the plurality of data object linguistic features with a corresponding plurality of trained model object linguistic features to thereby obtain a linguistic score.

40. The system of claim 39, wherein the computer is configured to fuse the correlation score, the temporal score and the linguistic score into a fusion value.

41. The system of claim 40, wherein the fusion value is expressed as:
$$F ( {s}_{i} ) = \frac{\begin{matrix}{w}_{1}^{1} {s}_{1}^{1} + {w}_{1}^{2} {s}_{1}^{2} … {w}_{1}^{k} {s}_{1}^{k} + {w}_{2} {s}_{2} + \\ {w}_{3}^{1} {s}_{3}^{1} + {w}_{3}^{2} {s}_{3}^{2} + … + {w}_{3}^{l} {s}_{3}^{l}\end{matrix}}{MAX [ F ( {s}_{t} ) ]}$$
wherein wᵢ represents trained weight values, sᵢ represents data object values, and sᵢ represents model object values.

42. The system of claim 41, wherein the at least one computer is further configured to compare the fusion value with a predetermined threshold value to obtain a decision value, the decision value being expressed as:
1−F(sᵢ)≦β_{ThreshHold}
wherein β_{Threshold} is the predetermined threshold value and F(sᵢ) is the fusion value.

43. The system of claim 33, wherein the at least one computer includes a plurality of computers, the plurality of computers, the at least one database, and the user interface being inter-coupled by a network.

44. The system of claim 43, wherein the network includes a local area network (LAN), a wide area network (WAN), a public switched telephone network (PSTN), and/or a packet data communication network.

45. The system of claim 44, wherein the plurality of computers further comprises:
a first computer including a training module and a recognition module residing thereon, the first computer being programmed to obtain, generate, compare, and combine as recited in claim 20, the recognition module and the training module being tangibly embodied, at least partially, in a computer readable medium having computer executable instructions disposed thereon; and
a host computer coupled to the first computer by way of the network, the host configured to host the at least one sensor.

46. The system of claim 45, wherein the sensor data captured by the at least one sensor includes visibility, lighting, temperature, and/or precipitation sensor data.

47. The system of claim 45, wherein the first computer generates the at least one data object vector from the sensor data, the plurality of data object features incorporating the sensor data.

48. The system of claim 33, wherein the user interface includes a display and at least one input device.

49. An object recognition method, the method comprising:
providing a trained reference vector, the trained reference vector being obtained by using of a genetic algorithm, the trained reference vector including a plurality of trained model object feature weights optimized using a genetic algorithm, the trained reference vector weights being optimized relative to a fitness function, the fitness function being an information based function, the trained reference vector weights corresponding to a known object or class of objects;
capturing an electronic representation of at least one object in a surveilled environment;
deriving a data object vector from the electronic representation of each of the at least one objects, the data object vector including a plurality of data object feature elements;
comparing the at least one data object vector with the trained reference vector to obtain a comparison metric; and
processing the comparison metric to obtain a decision value, the decision value representing a measure of the likeness of the at least one object relative to the known object or class of objects.

50. The method of claim 49, wherein the method of providing further comprises:
inputting training data representing the known object or class of objects to the genetic algorithm;
selecting the model object feature elements corresponding to statistically significant elements of the training data;
providing a weighting coefficient for each model object feature element; and
applying the model feature elements and the corresponding weighting coefficients to the genetic algorithm, the genetic algorithm optimizing the weighting coefficients in accordance with the fitness function.

51. The method of claim 50, wherein the information based function is expressed as:
$${{𝔍}_{fitness} ( C )}^{*} = E [ - \frac{ln ( 1 / F ( {s}_{ \overline{M}} )}{ln ( 1 / F ( {s}_{M} )} ] - α / {N}_{c}$$
in which
F(s_{\overline{M}}) are fusion values of objects not belonging to the matching object;
F(s_{M}) are fusion values that belong to the matching class object or individual object
α is a Penalty Constant;
N_{C} is a Number of Objects in the training set; and
E represents the expected value operator.

52. The method of claim 50, wherein the training data includes user data corresponding to the known object or class of objects, a training data image corresponding to the known object or class of objects, a previously trained reference vector corresponding to corresponding to the known object or class of objects, and/or region of interest rules describing statistically significant regions associated with the known object or class of objects.

53. The method of claim 49, wherein the electronic representation includes an image of the at least one object.

54. The method of claim 53, wherein the electronic representation includes a waveform representing the at least one object.

55. The method of claim 49, wherein the at least one object includes a plurality of objects, the step of deriving including the step of deriving a plurality of data object vectors for each object captured in the surveilled environment.

56. The method of claim 55, further comprising the step of eliminating statistically insignificant data object vectors.

57. The method of claim 56, wherein the step of eliminating includes the step of applying Tchebysheff s Theorem to the plurality of data object vectors to obtain a reduced set of data object vectors.

58. The method of claim 57, wherein each data object vector includes a correlation feature vector, a temporal feature vector, and a linguistic feature vector, and the trained reference vector includes a model correlation feature vector, a model temporal feature vector, and a model linguistic feature vector.

59. The method of claim 58, wherein the linguistic feature vector is obtained by applying a Mamdani min fuzzy inference operator to the user defined data to obtain linguistic features.

60. The method of claim 59, wherein the step of comparing includes correlating the correlation feature vector of each object vector in the reduced set with the model correlation feature vector to obtain a set of correlation scores, correlating the temporal feature vector of each object vector in the reduced set with the model temporal feature vector to obtain a set of temporal scores, and correlating the linguistic feature vector of each object vector in the reduced set with the model linguistic feature vector to obtain a set of linguistic scores.

61. The method of claim 60, wherein the correlation score, the temporal score, and the linguistic score for each data object vector are combined to obtain the data object fusion value for the data object vector.

62. The method of claim 61, wherein the step of processing includes the step of comparing each data object fusion value to a predetermined threshold value to obtain the decision value.

63. The method of claim 62, wherein the fusion value is expressed as:
$$F ( {s}_{i} ) = \frac{{w}_{1}^{1} {s}_{1}^{1} + {w}_{1}^{2} {s}_{1}^{2} … {w}_{1}^{k} {s}_{1}^{k} + {w}_{2} {s}_{2} + {w}_{3}^{1} {s}_{3}^{1} + {w}_{3}^{2} {s}_{3}^{2} + … + {w}_{3}^{l} {s}_{ 3}^{ l}}{MAX [ F ( {s}_{t} ) ]}$$
wherein wᵢ represents weight values, sᵢ represents data object values, and sₜ represents model object values.

64. The method of claim 62, wherein the decision value is expressed as:
1−F(sᵢ)≦β_{ThreshHold} wherein
β_{Threshold is the predetermined threshold value and F(s}ᵢ) is the fusion value.

65. The method of claim 49, wherein the genetic algorithm employs a dynamic length chromosome.
